(19) United States
(12) Patent Application Publication
(10) Pub. No.: US 2010/0125721 A1
(43) Pub. Date: May 20, 2010

(54) System and Method for Determining and/or Reducing Costs Associated with Utilizing Objects

(75) Inventor: Vincent R. Re, Saint James, NY (US)

Correspondence Address: BAKER BOTTS L.L.P., 2001 ROSS AVENUE, SUITE 600, DALLAS, TX, 75201-2980, US

(73) Assignee: Computer Associates Think, Inc., Islandia, NY (US)

(21) Appl. No.: 12/610,591

(22) Filed: Nov. 2, 2009

Related U.S. Application Data
(60) Provisional application No. 61/114,877, filed on Nov. 14, 2008.

(51) Int. Cl. G06F 9/30

(52) U.S. Cl. 712/220; 712/E09.016

(57) ABSTRACT

According to one embodiment of the present invention, a method includes receiving, in near real time, data associated with a utilization of one or more objects. The method further includes comparing the data associated with the utilization of the one or more objects with one or more rules associated with the utilization of the one or more objects. The method further includes determining, in near real time, a cost associated with the utilization of the one or more objects based at least on the comparison. The method further includes providing, in near real time, an indication of the cost associated with the utilization of the one or more objects.

### CROSS-REFERENCE TO RELATED APPLICATION

This application claims the benefit of priority under 35 U.S.C. §119(e) of U.S. Provisional Application Ser. No. 61/114,877, entitled “System and Method for Determining and/or Reducing Costs Associated With Utilizing Objects”, filed Nov. 14, 2008.

### TECHNICAL FIELD

The present disclosure relates generally to managing objects and more particularly to a system and method for determining and/or reducing costs associated with utilizing objects.

### BACKGROUND

Traditionally, objects in a computing environment have been monitored based on resource utilization (i.e., how busy is the server running) and service levels (i.e., what is the response time). These traditional techniques, however, are deficient because they do not allow for intelligent, business decision making.

### SUMMARY

According to one embodiment of the present invention, a method includes receiving, in near real time, data associated with a utilization of one or more objects. The method further includes comparing the data associated with the utilization of the one or more objects with one or more rules associated with the utilization of the one or more objects. The method further includes determining, in near real time, a cost associated with the utilization of the one or more objects based at least on the comparison. The method further includes providing, in near real time, an indication of the cost associated with the utilization of the one or more objects.

Particular embodiments of the present disclosure may allow an indication of the cost associated with the utilization of the one or more objects to be provided in near real time. By providing the cost in near real time, a user may be able to quickly understand the costs, and, as a result, may be able to make decisions more quickly, regarding manipulating the utilization of the objects to reduce the cost.

Particular embodiments of the present disclosure may further allow for monitoring the utilization of the one or more objects based on one or more rules associated with the cost of the utilization of the objects. Thus, the cost of the utilization of the objects may be determined, allowing decisions to be made about the utilization of the objects based on the cost.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a block diagram illustrating one embodiment of a system for determining costs associated with utilizing one or more objects;

FIG. 2 is a block diagram illustrating one embodiment of a system for determining costs associated with utilizing one or more objects;

FIG. 3 illustrates one embodiment of a utilization of one or more objects being manipulated in order to reduce the costs associated with the utilization of the one or more objects; and

FIG. 4 illustrates one embodiment of a method for determining the costs associated with utilizing one or more objects.

### DETAILED DESCRIPTION OF EXAMPLE EMBODIMENTS

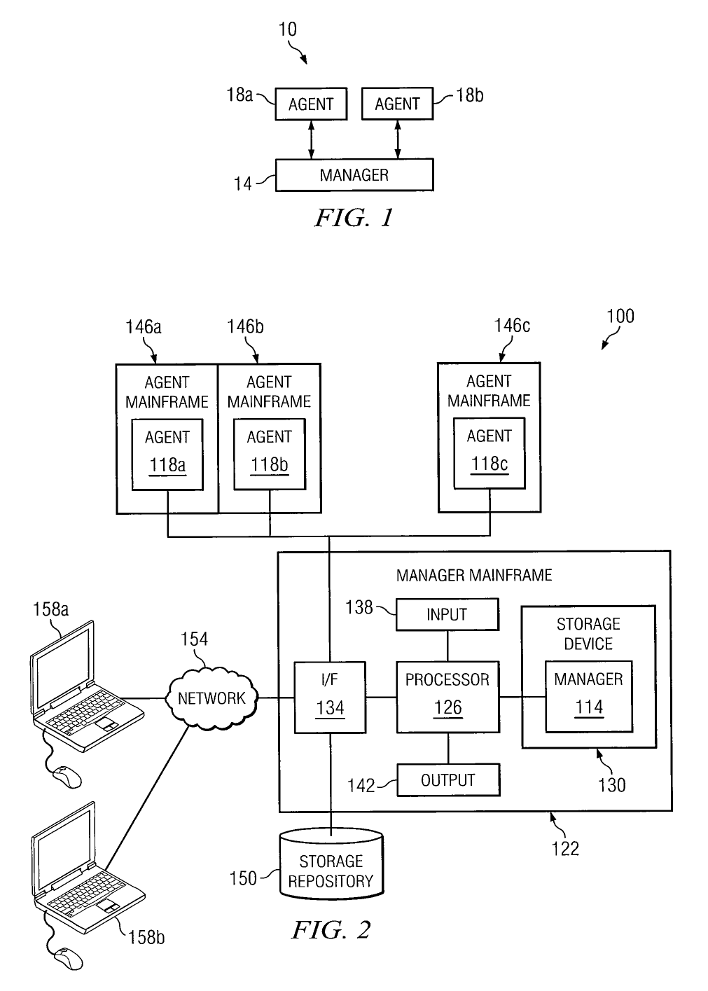

Embodiments of the present invention and its advantages are best understood by referring to FIGS. 1 through 4 of the drawings, like numerals being used for like and corresponding parts of the various drawings.

FIG. 1 is a block diagram illustrating one embodiment of a system 10 for determining costs associated with utilizing one or more objects. In one embodiment, system 10 includes a manager 14 that may determine a cost associated with the utilization of one or more objects. By determining a cost associated with the utilization of the objects, manager 14 may provide an indication of the cost to a user. As a result, the user may understand the cost associated with the utilization of the objects, and may alter the utilization of the objects in order to reduce the cost.

An object may refer to any component of a computer system or a computer network. For example, an object may refer to any type of hardware, any type of software, any combination thereof, or any other component of a computer system or a computer network. Utilization of an object may refer to any event associated with a cost. In one embodiment, utilization of an object may refer to any event that may be monitored. According to one embodiment, utilization of an object may refer to any type of event, or combination of events, that may occur in a computer system or computer network. For example, utilization of an object may refer to hardware being added or removed from a computer system, hardware being used, or turned on or off, software being added to or removed from a computer system, software being used, or executed or terminated, software being downloaded or transmitted, any combination thereof, or any other type of event that may occur in a computer system or computer network.

In a further embodiment, utilization of an object may refer to one or more utilizations of an object. For example, a utilization of an object may include any type of combination of utilizations of the object. In another embodiment, utilization of an object may refer to the number of users utilizing a software program, or the number of users utilizing hardware. For example, utilization of an object may refer to fifteen users utilizing a computer program.

In a further embodiment, utilization of an object may refer to a current level of utilization of a software program on a computer system. For example, utilization of an object may refer to a software program being utilized at a certain percentage, such as 80%, of its maximum utilization amount. A maximum utilization amount may, in one embodiment, refer to a maximum amount that an object may be used. For example, a software program may only be capable of (or set up for) using a certain amount of memory, processor capability, bandwidth, or any other computer related quantity. As another example, a software program may only be capable of being used for a certain amount of time, by a certain amount of users, or may have any other suitable restriction on its use.

According to the illustrated embodiment, system 10 includes manager 14 and one or more agents 18. Manager 14 may be operable to determine a cost associated with utilizing one or more objects. In one embodiment, manager 14 may comprise any suitable hardware and/or software. For example, manager 14 may include software executed on a mainframe. In one embodiment, manager 14 may determine a cost associated with the utilization of one or more objects by communicating with one or more agents 18. For example, an agent 18 may transmit data associated with the utilization of the objects to manager 14.

According to an embodiment where utilization of an object refers to a current utilization level of a software program running on hardware, manager 14 may receive data regarding the current utilization level of the software program. Using this data, manager 14 may, as one example, determine the cost associated with the current utilization level of the software program. In a further embodiment, manager 14 may be operable to provide an indication of the cost associated with the utilization of the objects. For example, manager 14 may provide an indication of the cost associated with the current utilization level of the software program. As a result, a user may understand the cost associated with the current utilization level of the software program.

In another embodiment, manager 14 may be operable to determine the cost associated with the utilization of the objects in near real time, and further operable to provide an indication of the cost in near real time. In one embodiment, near real time may refer to a time period that is different from the actual time period of the utilization of the objects by only a small amount of time. For example, near real time may refer to a time period that is different from the actual time period by only the amount of time that it may take to transmit various data and make various determinations using a computer system. As such, near real time may refer to a time period that is immediately after the actual time period of the utilization of the objects. As another example, near real time may refer to a time period that is different from the actual time period by a constant amount of time, such as five minutes. Accordingly, near real time may refer to a time period that is five minutes after the actual time period. In a further embodiment, near real time may refer to any other time period that occurs a relatively short duration (i.e., less than five minutes) after the actual time period.

Agents 18 may be operable to monitor a utilization of one or more objects. Agents 18 may comprise any suitable hardware and/or software. For example, agents 18 may comprise software executed on a mainframe. In one embodiment, by monitoring the utilization of the objects, agent 18 may be operable to collect data associated with the utilization. For example, in an embodiment where utilization of an object refers to a current utilization level of a software program executed on hardware, agent 18 may collect the current utilization level of the software program. As another example, in an embodiment where utilization of an object refers to a software program being executed on hardware, agent 18 may collect data regarding why the software program is being executed, how the software program is being used, and/or what software programs are already running on the hardware. In a further embodiment, agents 18 may be operable to communicate with manager 14. As such, any data collected by agent 18 about the utilization of the objects may be transmitted to manager 14 so that manager 14 may determine the cost associated with the utilization of the objects.

Modifications, additions, or omissions may be made to system 10 without departing from the scope of the invention. The components of system 10 may be integrated or separated. Moreover, the operations of system 10 may be performed by more, fewer, or other components. For example, the operations of manager 14 may be performed by more than one component. As used in this document, “each” refers to each member of a set or each member of a subset of a set.

FIG. 2 is a block diagram illustrating one embodiment of a system 100 for determining costs associated with utilizing one or more objects. According to the illustrated embodiment, system 100 includes manager 114 and one or more agents 118. Manager 114 of FIG. 2 is similar to manager 14 of FIG. 1, and agents 118 of FIG. 2 are similar to agents 18 of FIG. 1.

System 100 further includes a manager mainframe 122, one or more agent mainframes 146, a storage repository 150, a network 154, and one or more user stations 158. Manager mainframe 122 may refer to any suitable device operable to process data. For example, manager mainframe 122 may include a mainframe, server, host computer, workstation, web server, file server, a personal computer such as a laptop, or any other device operable to process data. In a further embodiment, manager mainframe 122 may execute any suitable operating system. For example, manager mainframe may execute IBM's zSeries/Operating System (z/OS), MS-DOS, PC-DOS, MAC-OS, WINDOWS, UNIX, OpenVMS, or any other appropriate operating systems, including future operating systems.

According to the illustrated embodiment of the invention, manager mainframe 122 includes a processor 126, a storage device 130, a communication interface 134, an input device 138, and an output device 142. Processor 126 may refer to any suitable device operable to execute instructions and manipulate data to perform operations for manager mainframe 122. Processor 126 may include, for example, any type of central processing unit (CPU).

Storage device 130 may refer to any suitable device operable for storing data and instructions. Storage device 130 may include, for example, a magnetic disk, flash memory, optical disk, or other suitable data storage device. According to the illustrated embodiment, storage device 130 may store manager 114 for execution by processor 126.

Communication interface 134 (I/F) may refer to any suitable device operable to receive input for manager mainframe 122, send output from manager mainframe 122, perform suitable processing of the input or output or both, communicate to other devices, or any combination of the preceding. Communication interface 134 may include appropriate hardware (e.g. modem, network interface card, etc.) and software, including protocol conversion and data processing capabilities, to communicate through a LAN, WAN, or other communication system that allows manager mainframe 122 to communicate to other devices. Communication interface 134 may include any suitable software operable to access data from various devices such as agents 118, input device 138, and/or storage repository 150. For example, communication interface 134 may access data from agents 118 by means of services using SOAP (XML) over HTTP(s). Communication interface 134 may also include any suitable software operable to transmit data to various devices such as agents 118, storage repository 150, and/or user stations 158. Communication interface 134 may include one or more ports, conversion software, or both.

Input device 138 may refer to any suitable device operable to input, select, and/or manipulate various data and information. Input device 138 may include, for example, a keyboard, mouse, graphics tablet, joystick, light pen, microphone, scanner, or other suitable input device. Output device 142 may refer to any suitable device operable for displaying information to a user. Output device 142 may include, for example, a video display, a printer, a plotter, or other suitable output device.

Agent mainframe 146 may refer to any suitable device operable to process data. For example, agent mainframe 146 may include a mainframe, server, host computer, workstation, web server, file server, a personal computer such as a laptop, or any other device operable to process data. According to one embodiment, agent mainframe 146 may be substantially similar to manager mainframe 122. For example, similar to manager mainframe 122, agent mainframe 146 may include a processor, a storage device, a communication interface, an input device, and an output device. In a further embodiment, a utilization of one or more objects may occur on agent mainframe 146. As such, in one embodiment, each agent mainframe 146a, b, and c further includes agent 118a, b, and c, respectively.

In one embodiment, agent mainframe 146 may execute z/OS. In further embodiments, agent mainframe 146 may execute any of the other well-known MS-DOS, PC-DOS, MAC-OS, WINDOWS, UNIX, OpenVMS, or other appropriate operating systems, including future operating systems. Although the illustrated embodiment includes three agent mainframes 146, system 100 may include less than three agent mainframes 146, or more than three agent mainframes 146. For example, system 100 may include only one agent mainframe 146.

Storage repository 150 may refer to any suitable device for storing data and instructions. Storage repository 150 may include, for example, a magnetic disk, flash memory, or optical disk, or other suitable data storage device. In one embodiment, storage repository 150 may store any data and instructions for manager 114. As such, manager 114 may access this data or instructions stored in storage repository 150 when determining a cost associated with utilizing one or more objects.

Network 154 may refer to any interconnecting system capable of transmitting audio, video, signals, data, messages, or any combination of the preceding. Network 154 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise internet, or any other suitable communication link, including combinations thereof.

User stations 158 may refer to any suitable device capable of communicating with manager mainframe 122 through network 154. For example, user station 158 may include a personal digital assistant, a computer such as a laptop, a cellular telephone, a mobile handset, or any other device capable of communicating with manager mainframe 122. In a further embodiment, user station 158 may be operable to receive an indication of a cost associated with a utilization of one or more objects, and further operable to display the indication of the cost associated with the utilization of the objects.

As discussed above, manager 114 may be operable to determine a cost associated with the utilization of one or more objects. In another embodiment, manager 114 may be further operable to discover one or more objects. Manager 114 may discover an object in any suitable way. For example, manager 114 may be operable to detect a signature associated with a software program loaded into system 100. As another example, manager 114 may be operable to detect hardware being added to system 100. In a further embodiment, any other component of system 100 may be operable to discover an object, and may be further operable to communicate the discovery to manager 114. As such, manager 114 may be operable to discover an object when an agent 118 discovers the object and communicates the discovery to manager 114.

In another embodiment, manager 114 may be further operable to discover one or more licenses associated with the utilization of one or more objects. A license may refer to any type of agreement regarding the cost of a utilization of an object. For example, a license may refer to an agreement between a user and a software company regarding the cost of using certain software. As another example, a license may refer to an agreement between a user and a hardware owner regarding the cost of using certain hardware.

In one embodiment, manager 114 may discover one or more licenses in any suitable way. For example, a license may be loaded in system 100 when a software program is installed onto system 100, or when new hardware is added onto system 100. As such, manager 114 may discover the license when manager 114, or any other element of system 100, discovers the software program or hardware. As another example, manager 114 may discover a license when an agent 118 communicates the license to manager 114 after a software program is loaded onto an agent mainframe 146. In a further embodiment, manager 114 may discover a license when the license is inputted into manager mainframe 122 using user station 158 or input device 138. In one embodiment, each discovered license may be transmitted to storage repository 150 for storage.

According to one embodiment, manager 114 may be operable to determine one or more rules using the one or more licenses. As discussed above, a license may refer to any type of agreement regarding the utilization of an object. According to one embodiment, each license may include one or more rules. A rule, in one embodiment, may refer to a factor for determining the cost of the utilization of the object. For example, the cost of the use of a software program may be determined based on a rule regarding how many different users are set up to use the software. As a further example, the cost of the use of a software program may be determined based on a rule regarding the length of the time period for which the software program is used. As another example, the cost of the use of a software program may be determined based on a rule regarding the amount of utilization of the software. In such an example, the cost may be determined by the percentage (i.e., average percentage, peak percentage, etc.) of utilization of the software program during a time period such as, for example, between 12:15 P.M. and 4:15 P.M. on every Wednesday of a week. In further embodiments, a rule may refer to any other suitable factor for determining the cost of the utilization of the object.

According to one embodiment, manager 114 may be operable to determine a rule by any suitable method. For example, manager 114 may be operable to analyze each license to determine one or more rules. In such an example, manager 114 may have access to various standard licenses, allowing manager 114 to compare/contrast the standard licenses to the license associated with utilizing the object. As a further example, the rules may be determined by a user and inputted into manager 114 using input device 138 or user station 158. As another example, manager 114 may access one or more rules stored in another location, such as storage repository 150.

In a further embodiment, manager 114 may be operable to instruct agents 118 to monitor the utilization of one or more objects based on the rules. For example, in an embodiment where utilization of an object may refer to the current utilization level of a software program on hardware, a rule may include the current utilization level of the software program at, for example, 12:10 P.M. on each Wednesday of a week. As such, in one embodiment, manager 114 may be operable to instruct agents 118 to monitor the utilization of the software program (i.e., the current utilization level of the software program) at 12:10 P.M. on each Wednesday. Accordingly, agents 118 may collect data regarding the current utilization level of the software program at 12:10 P.M. on Wednesday, and may further transmit the collected data to manager 114. In a further embodiment, agents 18 may constantly monitor the utilization of the objects. As such, agents 18 may constantly collect data associated with the utilization of the objects, and may constantly transmit the data to manager 114. In another embodiment, the data may be transmitted periodically, such as, for example, every few minutes. In a further embodiment, agents 18 may be operable to store the collected data prior to transmitting it to manager 114. As a result, the data may be accessed or retransmitted if the original transmission is unsuccessful.

As discussed above, manager 114 may be operable to determine the cost associated with the utilization of one or more objects. According to one embodiment, manager 114 may determine the cost associated with the utilization of the objects by comparing the data associated with the utilization of the objects with the one or more rules associated with the utilization of the objects. For example, manager 114 may compare a current utilization level of the software program to a rule regarding how much the current utilization level may cost. In such an example, the one or more rules may provide that the cost to use the software program may be $1,000 a week at a current utilization level of 50%, $2,000 a week at a current utilization level of 80%, and $3,000 a week at a current utilization level of 100%. As such, when the current utilization level of the software may be 80%, manager 114 may be operable to determine that the cost of using the software program is $2,000 for the week.

In a further embodiment, manager 114 may be operable to determine the cost associated with the utilization of the objects using one or more additional factors. For example, manager 114 may use one or more additional factors not included in the licenses in order to determine the cost associated with the utilization of the objects. Additional factors, in certain embodiments, may include a purchase/rental cost of the hardware that is running a particular software program, a cost associated with turning on and operating hardware that is running a particular software program, a cost associated with maintaining hardware that is running a particular software program, any other fixed costs, and any other suitable additional factors. Accordingly, manager 114 may be operable to determine the cost associated with the utilization of the objects by comparing the data associated with the utilization of the objects, the one or more rules associated with the utilization of the objects, and the one or more additional factors.

As discussed above, manager 114 may be operable to provide an indication of the cost associated with the utilization of one or more objects. For example, an indication may be provided by manager 114 so that a user may understand the cost associated with the utilization of the objects. In one embodiment, the indication may include any type of indicator. For example, the indication may be a visual display, an audio display, or any other suitable type of indicator that may allow a user to understand the cost of the utilization of the objects. A visual display may include, in certain embodiments, a graphical display (i.e., a graph), a textual display (i.e., a chart, a balance sheet, etc.), an alert (i.e., when the cost exceeds a threshold), or any other suitable visual display.

In a further embodiment, the indication may be broken down into any suitable format. For example, the indication may be broken down by type of software, type of hardware, configuration of hardware, programs utilizing the objects, or any other suitable category. In another embodiment, the format of the indication may be determined by a user. According to one embodiment, the indication may be provided to output device 142 of manager mainframe 122. As such, a user may access the indication directly at manager mainframe 122. In a further embodiment, the indication may be provided to user stations 158 through network 154. As such, a user may access the indication anywhere on network 154.

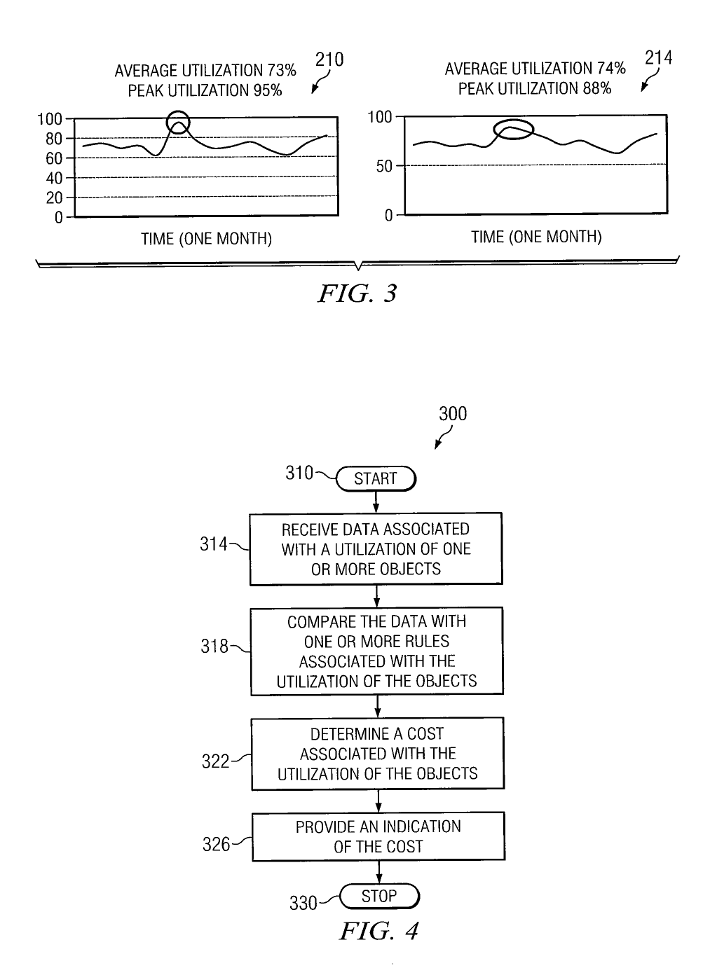

In a further embodiment, manager 114 may be operable to reduce the cost associated with the utilization of the objects. For example, manager 114 may be operable to determine how to reduce the cost of the utilization of the objects. In one embodiment, determining how to reduce the cost of the utilization of the objects may include determining that the utilization of the objects should be manipulated. FIG. 3 illustrates one embodiment of a utilization of one or more objects being manipulated in order to reduce the costs associated with the utilization of the one or more objects. According to the illustrated embodiment, utilization of an object may refer to the current utilization level of a software program. Furthermore, a license for the use of the software program may provide a rule stating that the cost of the software program may be determined based on the peak utilization level of the software program during a month. As such, when the peak utilization level during the month is 95% of the maximum utilization (as is shown in graph 210), the cost of utilizing the software program may be 95% of the maximum cost. To the contrary, if instead, the highest utilization level of the software program during the month is only 88% of the maximum (as is shown in graph 214), the cost of utilizing the software program may be only 88% of the maximum cost. This may provide a cost savings of 7%. Accordingly, the cost associated with the utilization of the software program may be reduced by lowering the peak utilization level.

Furthermore, the cost associated with the utilization of the software program may be reduced without reducing the use of the software program. For example, as discussed above, the cost associated with graph 210 may be 95% of the maximum cost. However, despite paying 95% of the maximum cost, the average use of the software program is only 73%. Contrary to this, the average use of the software program in graph 214 is 74%. As a result, the average use of the software program in graph 214 is higher than that of graph 210, but may be 7% cheaper than that of graph 210. Accordingly, manager 114 may be operable to determine how to reduce the cost of the utilization of the object without reducing the ability to utilize the object.

In further embodiments, determining how to reduce the cost of a utilization of an object may, as an example, include determining one or more time periods where it may be less expensive for the utilization of the object to occur (i.e., making the utilization of the object occur at time periods when it does not factor into the cost); determining more cost efficient configurations for the hardware where the utilization occurs (i.e., utilizing objects on two big mainframes, as opposed to four smaller mainframes); determining whether less expensive hardware may be used for the utilization of the objects (i.e., software programs may be less expensive to run on one piece of hardware than another); and/or determining that the utilization of the objects should occur on, or be moved to, hardware where a maximum utilization of the objects has already occurred (i.e., if a maximum utilization level has already resulted in a maximum cost for that hardware, any other utilization of objects may be moved over to that hardware without increasing the cost, thus reducing the cost on other hardware).

In a further embodiment, determining how to reduce the cost of a utilization of one or more objects may include determining that a different license should be used for the utilization of the objects. For example, if a software program is being used at a 100% utilization level at all times, it may be more cost efficient for the software program to be paid for based on a one-time purchase fee, rather than a variable utilization based fee. As another example, if a software program is being used at a 100% utilization level, but only for one day of the month, it may be more cost efficient for the software program to be paid for based on the number of transactions, rather than a one-time purchase fee or a variable utilization based fee. In one embodiment, manager 114 may be operable to analyze each of the licenses in order to determine if a better license should be used. In such an embodiment, manager 114 may compare/contrast various standard licenses, and may also analyze the data associated with the utilization of the objects.

In another embodiment, manager 114 may be operable to provide an indication regarding how to reduce the cost associated with the utilization of the objects. For example, if manager 114 determines that it would be more cost efficient to utilize an object at 4:00 P.M. on Sunday rather than at 9:00 A.M. on Monday, manager 114 may provide an indication of this determination to a user. As another example, if manager 114 determines that it would be more cost efficient to change the license associated with a certain utilization of an object from a transactional based license to a variable utilization based license, manager 114 may provide an indication of this determination to a user. In one embodiment, the indication may be provided to output device 142 of manager mainframe 122. In a further embodiment, the indication may be provided to user stations 158 through network 154. As such, a user may manipulate the utilization of the objects in order to reduce the cost of the utilization.

In a further embodiment, manager 114 may be operable to automatically reduce the cost of the utilization of the objects. For example, manager 114 may manipulate the utilization of the objects, without user intervention, in order to reduce the cost. For example, if a certain cost level needs to be avoided, manager 114 may prevent one or more utilizations of the objects from occurring. As another example, if it is cheaper to utilize the objects during off peak times, manager 114 may cause the utilization of the objects to occur during those off peak times. In one embodiment, manager 114 may be operable to automatically reduce the cost using agents 118. For example, agents 118 may receive instructions from manager 114 to cause, prevent, or manipulate a utilization of an object. Accordingly, agents 118 may make the changes to the utilization of the objects occurring on agent mainframes 146.

In a further embodiment, manager 114 may be operable to determine a cost associated with a utilization of one or more objects under hypothetical scenarios. For example, manager 114 may receive hypothetical scenarios from a user, and may provide an indication of the cost associated with the utilization of the objects under the hypothetical scenarios. As one example, manager 114 may receive a hypothetical scenario where the time period for a utilization of an object is changed. As a further example, manager 114 may receive a hypothetical scenario where the hardware utilizing the object is changed. In such examples, manager 114 may provide an indication that the change may increase the cost, decrease the cost, or not affect the cost of the utilization of the object. According to one embodiment, manager 114 may receive the hypothetical scenario from any suitable source. For example, manager 114 may receive the hypothetical scenario from a user at user stations 158, or a user at input device 138. In a further embodiment, manager 114 may determine the cost associated with the utilization of the objects under hypothetical scenarios by comparing the hypothetical scenario with various rules and other factors.

Modifications, additions, or omissions may be made to system 100 without departing from the scope of the invention. The components of system 100 may be integrated or separated. Moreover, the operations of system 100 may be performed by more, fewer, or other components. For example, the operations of one or more agents 118 may be performed by manager 114. As another example, the operations of storage repository 150 may be performed by storage device 130.

FIG. 4 illustrates one embodiment of a method 300 for determining the costs associated with utilizing one or more objects. The method begins at step 310. At step 314, data associated with a utilization of one or more objects is received. In one embodiment, utilization of an object may refer to a current level of utilization of a software program on a computer system. In a further embodiment, the data may be received in near real time. For example, it may be received immediately after the utilization of the objects occurs. In another embodiment, the data may be received at a manager. In such an embodiment, the data may be received from an agent that is monitoring the utilization of the objects. In a further embodiment, the agent may be monitoring the utilization of the objects as a result of receiving instructions from the manager.

At step 318, the data associated with the utilization of the objects may be compared with one or more rules associated with the utilization of the objects. In one embodiment, the rules may be determined by the manager using one or more licenses associated with the utilization of the objects. In a further embodiment, the rules may include one or more factors for determining the cost of the utilization of the objects. At step 322, a cost associated with the utilization of the objects is determined based on the comparison. For example, the cost may be determined by comparing the data and the one or more rules. In a further embodiment, the cost may be determined using various additional factors. For example, the cost may include various fixed costs associated with the utilization of the objects. In a further embodiment, the cost may be determined in near real time.

At step 326, an indication of the cost is provided. In one embodiment, the indication of the cost may be provided in near real time. In a further embodiment, the indication may be provided by the manager to a user so that the user may understand the cost associated with the utilization of the objects. In a further embodiment, the manager may further provide an indication of how to reduce the costs associated with utilization of the objects. At step 330, the method ends.

Modifications, additions, or omissions may be made to method 300 without departing from the scope of the invention. The steps of method 300 may be integrated or separated. Moreover, the steps of method 300 may be performed by more, fewer, or other components.

As illustrated above, particular embodiments of the present disclosure may allow for monitoring one or more objects based on the financial cost associated with a utilization of one or more objects. Particular embodiments of the present disclosure may allow for an automated and rule-based monitoring of the cost associated with a utilization of one or more objects. Thus, the cost of the utilization of the objects may be determined and analyzed, allowing automated responses to be made about the utilization of the objects based on the costs.

Particular embodiments of the present disclosure may allow for a hypothetical cost to be determined for a utilization of one or more objects under a hypothetical scenario. As a result, hypothetical scenarios may be analyzed in order to determine whether they should be implemented with the utilization of the objects.

Although the present disclosure has been described in several embodiments, a myriad of changes, substitutions, and modifications may be suggested to one skilled in the art, and it is intended that the present disclosure encompass such changes, substitutions, and modifications as fall within the scope of the present appended claims.

What is claimed is:

1. A method, comprising:
receiving, in near real time, data associated with a utilization of one or more objects;
comparing the data associated with the utilization of the one or more objects with one or more rules associated with the utilization of the one or more objects;
determining, in near real time, a cost associated with the utilization of the one or more objects based at least on the comparison; and
providing, in near real time, an indication of the cost associated with the utilization of the one or more objects.

2. The method of claim 1, further comprising providing an indication of how to reduce the cost associated with the utilization of the one or more objects.

3. The method of claim 1, further comprising:
discovering the one or more objects;
discovering one or more licenses associated with the utilization of the one or more objects;
determining the one or more rules using the one or more licenses; and
providing for monitoring, in near real time, of the utilization of the one or more objects based at least on the one or more rules.

4. The method of claim 1, wherein the utilization of the one or more objects comprises a current utilization level of software.

5. The method of claim 1, wherein the one or more rules comprise a utilization level during a specific time frame.

6. The method of claim 1, further comprising monitoring the utilization of the one or more objects in order to collect the data associated with the utilization of the one or more objects.

7. The method of claim 1, further comprising providing an indication of a hypothetical cost associated with the utilization of the one or more objects under a hypothetical scenario.

8. The method of claim 1, further comprising comparing the data associated with the utilization of the one or more objects with one or more factors associated with hardware running a software program.

9. The method of claim 1, further comprising receiving the one or more rules associated with the utilization of the one or more objects from a storage repository or a user.

10. A system, comprising:
a processor; and
a program of instructions embodied on a computer-readable medium and operable, upon execution by the processor, to:
receive, in near real time, data associated with a utilization of one or more objects;
compare the data associated with the utilization of the one or more objects with one or more rules associated with the utilization of the one or more objects;
determine, in near real time, a cost associated with the utilization of the one or more objects based at least on the comparison; and
provide, in near real time, an indication of the cost associated with the utilization of the one or more objects.

11. The system of claim 10, the program of instructions further operable, upon execution by the processor, to provide an indication of how to reduce the cost associated with the utilization of the one or more objects.

12. The system of claim 10, the program of instructions further operable, upon execution by the processor, to:
discover the one or more objects;
discover one or more licenses associated with the utilization of the one or more objects;
determine the one or more rules using the one or more licenses; and
provide for monitoring, in near real time, of the utilization of the one or more objects based at least on the one or more rules.

13. The system of claim 10, wherein the utilization of the one or more objects comprises a current utilization level of software.

14. The system of claim 10, wherein the one or more rules comprise a utilization level during a specific time frame.

15. The system of claim 10, further comprising:
a second processor; and
a second program of instructions operable, upon execution by the second processor, to monitor the utilization of the one or more objects in order to collect the data associated with the utilization of the one or more objects.

16. The system of claim 10, the program of instructions further operable, upon execution by the processor, to provide an indication of a hypothetical cost associated with the utilization of the one or more objects under a hypothetical scenario.

17. The system of claim 10, the program of instructions further operable to compare the data associated with the utilization of the one or more objects with one or more factors associated with hardware running a software program.

18. The system of claim 10, the program of instructions further operable to receive the one or more rules associated with the utilization of the one or more objects from a storage repository or a user.

19. Logic for determining costs associated with utilizing objects, the logic encoded on a computer-readable medium and operable, upon execution, to:
receive, in near real time, data associated with a utilization of one or more objects;
compare the data associated with the utilization of the one or more objects with one or more rules associated with the utilization of the one or more objects;
determine, in near real time, a cost associated with the utilization of the one or more objects based at least on the comparison; and
provide, in near real time, an indication of the cost associated with the utilization of the one or more objects.

20. The logic of claim 19, the logic further operable, upon execution, to provide an indication of how to reduce the cost associated with the utilization of the one or more objects.

21. The logic of claim 19, the logic further operable, upon execution, to:
discover the one or more objects;
discover one or more licenses associated with the utilization of the one or more objects;
determine the one or more rules using the one or more licenses; and
provide for monitoring, in near real time, of the utilization of the one or more objects based at least on the one or more rules.

22. The logic of claim 19, wherein the utilization of the one or more objects comprises a current utilization level of software.

23. The logic of claim 19, wherein the one or more rules comprise a utilization level during a specific time frame.

24. The logic of claim 19, further comprising a second logic operable, upon execution, to monitor the utilization of the one or more objects in order to collect the data associated with the utilization of the one or more objects.

25. The logic of claim 19, the logic further operable, upon execution, to provide an indication of a hypothetical cost associated with the utilization of the one or more objects under a hypothetical scenario.

26. The logic of claim 19, the logic further operable, upon execution, to compare the data associated with the utilization of the one or more objects with one or more factors associated with hardware running a software program.

27. The logic of claim 19, the logic further operable, upon execution, to receive the one or more rules associated with the utilization of the one or more objects from a storage repository or a user.
